(19) United States
(12) Patent Application Publication
(10) Pub. No.: US 2002/0044736 A1
(43) Pub. Date: Apr. 18, 2002

(54) Optical filter apparatus and method of designing thereof

(76) Inventors: Yu Mimura, Tokyo (JP); Kazuyo Mizuno, Tokyo (JP)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/846,035

(22) Filed: Apr. 30, 2001

(30) Foreign Application Priority Data
May 1, 2000 (JP) 2000-132476

(51) Int. Cl. G02B 6/26; G02B 5/20

(52) U.S. Cl. 385/27; 385/42; 359/885; 359/577

(57) ABSTRACT

An optical filter apparatus and a method of designing an optical filter having a target loss wavelength characteristic. The optical filter is formed by combining a plurality of optical parts, each having a periodic loss wavelength characteristic with respect to the wavelength. The loss wavelength characteristic may be determined using a theoretical equation that includes phase and amplitude determining parameters. Nonlinear fitting is used to determine first optimum solutions for respective phase determining parameters from predetermined numerical values. Additionally, groups of numerical values are determined from numerical ranges in the vicinities of the first optimum solutions and nonlinear fitting analysis. Consequently, optimum solutions are successively calculated and respective parameters are determined to reach final optimum solutions. Finally, the determined parameters are used to approximate the loss wavelength characteristic of the optical filter.

### BACKGROUND OF THE INVENTION

As one of optical communication systems for realizing a large capacity formation, there is provided an optical wavelength division multiplexing (WDM). The system is a system of multiplexing and transmitting a plurality of optical signals having wavelengths different from each other by a single piece of optical transmission path comprising, for example, an optical fiber and there has frequently been carried out an investigation on an optical wavelength division multiplexing system utilizing the system.

Further, there has conventionally been carried out an investigation on an optical semiconductor amplifier using an optical semiconductor. Further, in recent times, there has been carried out an investigation on an optical fiber type optical amplifier constituting an amplification medium by an optical fiber doped with a rare earth element such as an optical fiber doped with erbium and in recent years, there has rapidly been realized an optical fiber type optical amplifier. The optical amplifier can amplify summarizingly light having a wavelength in a gain wavelength band. Therefore, a large capacity long distance transmission system is expected to realize by applying the optical amplifier to the optical wavelength division multiplexing.

### SUMMARY OF THE INVENTION

According to an aspect of the invention, there are provided a method of designing an optical filter apparatus and an optical filter apparatus fabricated by using the design method. There is provided a method of designing an optical filter apparatus for designing the optical filter apparatus by combining N (N is an integer equal to or larger than 2) having periodic loss wavelength characteristics with respect to a wavelength, the method comprising the steps of:

approximating a loss wavelength characteristic of the optical filter apparatus by a theoretical equation having phase determining parameters mⱼ (j is an integer incremented by 1 successively from 1 through N as in 1, 2, 3, . . . N) for determining phases of the loss wavelength characteristics of N of the respective optical parts and amplitude determining parameters bⱼ for determining amplitudes of the loss wavelength characteristics of the respective optical parts;

determining a predetermined group of a plurality of different numerical values as a first stage;

determining all of sets of the phase determining parameters mⱼ comprising N of numerical values different from each other having different combinations of the numerical values from the numerical values of the group of initial values of the phase determining parameters;

calculating solutions minimizing a square error between respective theoretical values and a target loss wavelength characteristic of the optical filter apparatus when the numerical values of the phase determining parameters of the respective optical parts of the respective phase determining parameters mⱼ of the respective sets, are substituted for the phase determining parameters mⱼ in the theoretical equation providing the initial values of the amplitude determining parameters bⱼ, as first optimum solutions of the phase determining parameters mⱼ by nonlinear fitting;

thereafter determining respective groups of numerical values in ranges proximate to respective numerical values constituting the first optimum solutions of the phase determining parameters mⱼ and determining the phase determining parameters on mⱼ of all of sets having different combinations of numerical values by selecting numerical values one by one from the groups of the respective numerical values as a second stage;

calculating solutions minimizing the square error between the respective theoretical values and the target loss wavelength characteristic of the optical filter apparatus when the numerical values of the phase determining parameters of the respective optical parts are substituted for the phase determining parameters mⱼ in the theoretical equation at the respective phase determining parameters mⱼ of the respective sets as second optimum solutions of the phase determining parameters mⱼ by the nonlinear fitting;

successively calculating the optimum solutions of the phase determining parameters mⱼ by repeatedly carrying out an operation similar to an operation at the second stage at a third stage and thereafter;

determining the phase determining parameters mⱼ calculated when a predetermined condition of converging in accordance with calculating the optimum solutions reaches a set converging condition as final optimum solutions and designing N of the respective optical parts by using the phase determining parameters mⱼ of the final optimum solutions; and

constituting the optical filter apparatus having the target loss wavelength characteristic by combining N of the designed optical parts.

### BRIEF DESCRIPTION OF THE DRAWINGS

Exemplify embodiments of the invention will now be described in conjunction with drawings in which:

FIG. 1 is a graph showing a measured value of light transmission loss with respect to a wavelength along with a target loss wavelength characteristic according to a first embodiment of an optical filter apparatus of the invention;

FIG. 2 is an explanatory view showing an example of filter arrangement according to the first embodiment of the optical filter apparatus of the invention;

FIG. 3 illustrates a graph of subjecting the target loss wavelength characteristic according to the first embodiment to Fourier transformation and a graph showing a phase determining parameter of respectives of four etalon filters constituting the optical filter apparatus;

FIG. 4 is an explanatory view of a constitution showing a second embodiment of an optical filter apparatus according to the invention along with input/output portions; and

FIG. 5A is a graph showing a target loss wavelength characteristic, and FIG. 5B is a graph showing a designed loss wavelength characteristic which is designed based on the target loss wavelength characteristic.

### DESCRIPTION OF THE PREFERRED EMBODIMENT

Generally, in an optical fiber type optical amplifier and in an optical semiconductor amplifier, gains of these are provided with a wavelength dependency. A magnitude of gain differs by a wavelength of light inputted to an optical amplifier and therefore, when wavelength multiplex light is summarizingly incident on an optical amplifier, intensity of light outputted from the optical amplifier differs by the wavelength. By a difference in intensity of output light caused by the wavelength, there poses a problem of cross talk among the respective wavelengths. Further, when the intensity of the output light from the optical amplifier differs, there poses a problem in view of setting a reception level in which a reception level of a wavelength multiplexed optical reception portion for receiving the output light must be set to a value which differs by, for example, wavelength of received light.

Hence, in order to compensate for the gain wavelength dependency of the optical amplifier, there is proposed a method of inserting an optical gain equalizer to an optical fiber type optical amplifier. According to the method, an optical filter apparatus having a target loss wavelength characteristic (for example, as shown by FIG. 5A, prescribed with specified loss values with regard to respective discontinuous wavelengths) for flattening gain wavelength dependency of the optical fiber type optical amplifier, is constituted by a combination of only etalon filters and the optical filter apparatus is inserted to the optical fiber type optical amplifier as an optical gain equalizer. Further, the target loss wavelength characteristic is a characteristic produced by inverting a gain wavelength characteristic of the optical fiber type optical amplifier by making the characteristic upside down and by inserting the optical gain equalizer to the optical amplifier, the optical transmission loss of light which has transmitted through the optical amplifier and the optical gain equalizer is made constant regardless of wavelength.

There has been proposed a method of designing an optical filter apparatus functioning as the optical gain equalizer in, for example, Japanese Patent Application (laid-on No. 9-289349). According to the proposal, a loss curve compensating for gain wavelength dependency of an optical amplifier with regard to a wavelength of signal light, is given by expanding the loss curve in Fourier series with respect to wavelength. Further, the gain of an optical amplifier is flattened by combining etalon filters each having a loss characteristic in a shape of sine wave having amplitude and period the same as those of a loss characteristic in a shape of sine wave provided by expansion into Fourier series,

However, a waveform having an arbitrary shape is represented in the form of an infinite series of sine wave or cosine wave. Therefore, it seems that a characteristic proximate to a waveform having the arbitrary shape can be provided by using a large number of the etalon filters. However, it is actually impossible to form an optical gain equalizer by using etalon filters of a large number proximate to infinity and for convenience in view of fabrication, the number of etalon filters forming the optical gain equalizer is at least about four as a limit thereof. Therefore, the waveform of the arbitrary shape cannot be provided by the proposed method and there cannot be designed an optical filter apparatus effectively compensating for the gain wavelength dependency of the optical amplifier.

Hence, there is proposed a method of providing parameters respectively determining phases and amplitudes of loss wavelength characteristics of a plurality of optical parts constituting an optical filter apparatus by a method of nonlinear fitting in place of the method by Fourier series expansion, described above, in Japanese Patent Application (Application No: 11-017871) filed on Jan. 27, 1999 and Japanese Patent Application (Application No.: 2000-15484) filed on Jan. 25, 2000.

According to the method, the respective parameters are determined by calculating an optimum solution such that a square error between a designed loss wavelength characteristic (loss wavelength characteristic continuously designed to satisfy a discontinuous target loss wavelength characteristic, for example, characteristic shown by FIG. 5B) represented by a theoretical equation including the parameters respectively determining, for example, phase and amplitude, is minimized. When the optical filter apparatus is designed by the method, in comparison with the case of designing the optical filter apparatus by the method of expansion into Fourier series, an optical filter apparatus having a characteristic proximate to the target loss wavelength characteristic can be provided. For example, the gain wavelength dependency of the optical amplifying apparatus can effectively be compensated.

However, for example, a loss wavelength characteristic of an etalon filter constituting an optical filter apparatus is provided with a loss characteristic in a shape of sine/cosine wave and is provided with a characteristic curve substantially the same as a designed wavelength characteristic when a parameter for determining phase is provided with a value of phase which differs by a period multiplied by an integer. Therefore, a square error between the designed wavelength characteristic and the target loss wavelength characteristic, is provided with a minimum value for respective period and there are a number of minimum points at a vicinity of a desired solution.

In such a case, in view of the property of nonlinear fitting, an initial value which a designer firstly sets as the parameter for determining phase must be present at a vicinity of the desired solution, however, according to the proposed method of designing an optical filter apparatus by using the nonlinear fitting, a specific method of the nonlinear fitting is not shown. Therefore, there poses a problem that there is needed a number of times of calculation as much as the numbers of the minimum points while changing the initial value of the parameter for determining phase.

According to an aspect of the invention, there is provided an optical filter apparatus having a target loss wavelength characteristic capable of very effectively compensating for gain wavelength dependency of, for example, an optical amplifying apparatus. Further, there is provided a method of designing an optical filter apparatus for precisely designing such an optical filter apparatus by a simple method.

FIG. 2 shows a constitution of a first embodiment of an optical filter apparatus according to the invention. As shown by FIG. 2, an optical filter apparatus 6 according to the first embodiment is formed by arranging four sheets, in this example, of etalon filters (etalon filter elements) 5 as optical parts at intervals.

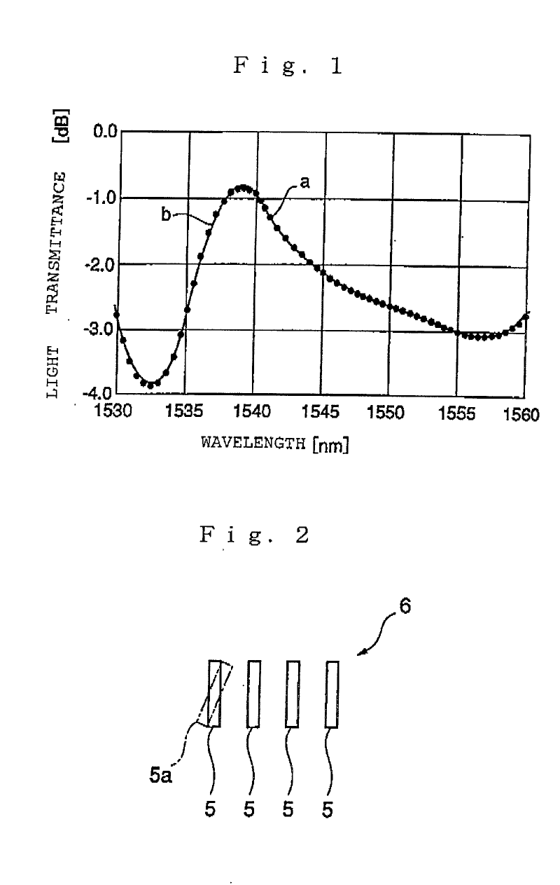

The optical filter apparatus 6 in respective embodiments shown below, is provided in, for example, an optical amplifying apparatus. A number of dots “a” in FIG. 1 show discontinuous specified loss values with regard to respective wavelengths of a target loss wavelength characteristic of the optical filter apparatus 6.

According to the first embodiment, the etalon filters 5 are provided with a loss wavelength characteristic for substantially completely compensating for gain wavelength dependency in a set wavelength range which is previously set to include a wavelength range used by the optical amplifying apparatus. That is, by combining the etalon filters 5, the optical filter apparatus 6 is constituted by designing the optical filter apparatus 6 to provide the target loss wavelength characteristic (characteristic shown by the dots “a” of FIG. 1).

A description will be given of a method of designing the optical filter apparatus 6 according to the first embodiment. First, as a representative example, in designing the first embodiment, there is shown an example of designing the optical filter apparatus 6 by combining N (N=4 in the embodiment) of the etalon filter 5 having a periodic loss wavelength characteristic with respect to the wavelength as optical parts.

First, the loss wavelength characteristic of the optical filter apparatus 6 is approximated by a theoretical equation including a phase determining parameter mⱼ (“j” is an integer incremented successively by 1 from 1 to N as in 1, 2, 3, . . . N, 4 in the case of the embodiment) for determining the phase of the loss wavelength characteristic of the respective etalon filter 5 and an amplitude determining parameter bⱼ for determining the amplitude of the loss wavelength characteristic of the respective etalon filter 5. Further, the suffix “j” is a value for identifying the respective etalon filter 5 and, for example, j=1 for the etalon filter 5 at the leftmost side of FIG. 2, j=2 for the etalon filter 5 contiguous thereto, j=3 for the etalon filter 5 contiguous thereto and j=4 for the etalon filter at the rightmost side.

When the loss wavelength characteristic (transmission characteristic) of the respective etalon filter 5 is designated by notation T, a frequency of incident light is designated by notation “f”, the transmission characteristic T of the respective etalon filter 5 is approximately represented by Equation (1) which becomes Equation (2) shown in dB unit.

T=1/{1+bⱼ·sin²(π·f·mⱼ)} (1)

T=−10×log₁₀{1+bⱼ·sin²(π·f·mⱼ)} (2)

Therefore, in the first embodiment, transmission characteristic T of the optical filter apparatus constituted by combining 4 sheets of the etalon filters 5, is approximated by Equation (3) as follows.

$$T = - 10 \times {log}_{10} \{ 1 + {b}_{1} \cdot {sin}^{2} ( π \cdot f \cdot {m}_{1} ) \} - 10 \times {log}_{10} \{ 1 + {b}_{2} \cdot {sin}^{2} ( π \cdot f \cdot {m}_{2} ) \} - 10 \times {log}_{10} \{ 1 + {b}_{3} \cdot {sin}^{2} ( π \cdot f \cdot {m}_{3} ) \} - 10 \times {log}_{10} \{ 1 + {b}_{4} \cdot {sin}^{2} ( π \cdot f \cdot {m}_{4} ) \} \qquad ( 3 )$$

Next, optimum solutions of the amplitude determining parameters bⱼ and the phase determining parameters mⱼ are respectively calculated. An explanation will be given of a method of designing the optical filters according to an embodiment by describing three specific examples of ways of calculating the optimum solutions as follows.

First, an explanation will be given of a first specific example of a method of calculating the optimum solutions, of the amplitude determining parameters bⱼ and the phase determining parameters mⱼ. First, initial values of the amplitude determining parameters bⱼ and initial values of the phase determining parameters mⱼ are respectively determined as follows and substituted for Equation (3) and the optimum solutions of the amplitude determining parameters bⱼ and the phase determining parameters mⱼ are respectively calculated by carrying out nonlinear fitting.

That is, first, as a first stage, there is determined a predetermined group of a plurality of different numerical values as a group of initial values of amplitude determining parameters and there are determined all of sets of the amplitude determining parameters bⱼ comprising N (in this case, 4 equal to the number of the etalon filters) of numerical values having different combinations of numerical values from numerical values of the group of initial values of the amplitude determining parameters. Further, similarly, there is determined a predetermined group of a plurality of different numerical values as a group of initial values of the phase determining parameters and there are determined all of sets of the phase determining parameters mⱼ comprising N (in this case, 4 equal to the number of the etalon filters) of numerical values different from each other having different combinations of numerical values from numerical values of the group of initial values of the phase determining parameters.

Further, there is constituted 1 pair by one set selected from all of the determined sets of the amplitude determining parameters bⱼ and one set selected from all of the sets of the phase determining parameters mⱼ and there are produced all of pairs having different combinations by the sets of the amplitude determining parameters bⱼ and the sets of the phase determining parameters mⱼ. Further, there is calculated square error between theoretical values when the numerical values of the amplitude determining parameters bⱼ and the phase determining parameters mⱼ provided to the pairs are substituted for the amplitude determining parameters bⱼ and the phase determining parameters mⱼ in the theoretical equation, pair by pair. Further, first optimum solutions are constituted by the amplitude determining parameters bⱼ and the phase determining parameters mⱼ of the pair minimizing the square error in the respective pairs by calculating solutions minimizing the square error by nonlinear fitting.

Specifically, as an example, the initial values of the amplitude determining parameters bⱼ are determined as follows, That is, as apparent from Equation (2), when the value is set to 2.0, the transmission characteristic T of the etalon filter 5 becomes a minimum value of −4.77 dB. Therefore, a range of the amplitude determining parameter is set to be equal to or smaller than 2.0, firstly, 2.0 is divided in 5 and 0.40, 0.80, 1.20, 1.60, 2.00 are determined as a group of initial values of the amplitude determining parameters. Further, from numerical values of the initial values, all of combinations of the amplitude determining parameters b₁, b₂, b₃, b₄, that is, all of sets of the amplitude determining parameters bⱼ are determined.

Meanwhile, as a group of initial values of the phase determining parameters, there are determined numbers different from each other from 0.3×10⁻¹² through 2.7×10⁻¹² at intervals of 0.3×10⁻¹² (0.3×10⁻¹², 6×10⁻¹², . . . 2.7×10⁻¹²) and from the numerical values in the group of initial values of the phase determining parameters, there are determined all of different combinations of the phase determining parameters m₁, m₂, m₃, m₄, that is, all of sets of the phase determining parameters mⱼ.

Further, although values of the group of initial values of the phase determining parameters may be any values, preferably, by regarding 1530 nm through 1536 nm in the target loss wavelength characteristic as a component constituted by a minimum (½) period, a consideration may be given to a component having 1 period by 3.0 nm of about a half thereof. That is, a maximum value of the group of initial values of the phase determining parameters may be determined to constitute a period larger than about a half of a pertinent wavelength interval regarded as a component having the minimum period of the target loss wavelength characteristic.

That is, the maximum value of the group of initial values of the phase determining parameters may be determined, for example, as follows. That is, when a wavelength interval of one period at a vicinity of a wavelength λ₁ is designated by notation Δλ, a relationship between Δλ and a frequency interval Δf of incident light in correspondence therewith, is given by Equation (4) by designating the velocity of light by notation c, meanwhile, the phase determining parameter mⱼ constituting one period by the frequency interval Δf is given by Equation (5).

Δf=(λ₁)−{c/(λ₁+Δλ)} (4)

mⱼ=1/Δf (5)

Therefore, according to one embodiment, for example, when Δλ=3.0 nm and λ₁=1530 nm are given, the frequency interval Δf is determined. Since the frequency interval is minimum, a maximum value of a group of initial values of the phase determining parameters in correspondence therewith can be determined and when calculated in this way, a value pertinent as the maximum value of the group of initial values of the phase determining parameters becomes 2.6×10⁻¹². Hence, 2.7×10⁻¹² is determined as the maximum value of the group of initial values of the phase determining parameters at a vicinity of the value to facilitate calculation.

Next, there are determined all of combinations of all of combinations of the determined amplitude determining parameters b₁, b₂, b₃, b₄ (all of sets of the amplitude determining parameters bⱼ) and all of different combinations of the phase determining parameters m₁, m₂, m₃, m₄ (all of sets of the phase determining parameters mⱼ). That is, there are determined all of pairs of combinations of sets of the amplitude determining parameters bⱼ and sets of the phase determining parameters mⱼ. Further, the numerical values of the sets of the amplitude determining parameters bⱼ and the sets of the phase determining parameters mⱼ of the pairs, are substituted for the amplitude determining parameters b₁, b₂, b₃, b₄ and the phase determining parameters m₁, m₂, m₃, m₄ in Equation (3) pair by pair

Next, there are calculated respective theoretical values when the respective combinations are substituted for the phase determining parameters m₁, m₂, m₃, m₄ and the amplitude determining parameters b₁, b₂, b₃, b₄ of Equation (3) one by one (pair by pair). Further, there are calculated respective optimum values of the amplitude determining parameters b₁, b₂, b₃, b₄ and the phase determining parameters m₁, m₂, m₃, m₄ by carrying out nonlinear fitting to minimize square error between the theoretical values and the target loss wavelength characteristic of the optical filter apparatus and first optimum solutions of the sets of the amplitude determining parameters bⱼ and the phase determining parameters mⱼ, are determined by the optimum solutions minimizing square error in the respective optimum solutions of all of the combinations (all of the pairs).

When the first optimum solutions of the phase determining parameters m₁, m₂, m₃, m₄ and the phase determining parameters b₁, b₂, b₃, b₄ are calculated as described above, as a second stage, there is determined a predetermined group of a plurality of different numerical values as a group of initial values of the amplitude determining parameters and there are determined all of combination of the amplitude determining parameters bⱼ from numerical values of a group of initial values of the amplitude determining parameters. Meanwhile, according to the phase determining parameters mⱼ, there are respectively determined groups of pluralities of different numerical values at numerical value ranges at vicinities of the first optimum solutions of the respective numerical values constituting the phase determining parameters mⱼ (specifically, when the first optimum solutions m₁, m₂, m₃, m₄ are calculated, there are determined groups of pluralities of different numerical values in a numerical value range at a vicinity of a numerical value of m₁, a numerical value range at a vicinity of a numerical value of m₂, a numerical value range at a vicinity of a numerical value of m₃ and a numerical value range at a vicinity of a numerical value of m₄) and there are determined the phase determining parameters mⱼ of all of sets comprising N (in this case, 4) of numerical values having different combinations of numerical values by selecting numerical values from numerical values of the respective groups one by one.

Next, there are produced all of pairs by different combinations of all of sets of the determined amplitude determining parameters bⱼ and all of sets of the phase determining parameters mⱼ set by set. Further, there are calculated solutions minimizing square error between respective theoretical values and the target loss wavelength characteristic of the optical filter apparatus when the numerical values are substituted for the amplitude determining parameters bⱼ and the phase determining parameters mⱼ of the theoretical equation pair by pair, by nonlinear fitting.

Further, there are calculated optimum solutions of the amplitude determining parameters bⱼ and the phase determining parameters mⱼ of the respective pairs and second optimum solutions are constituted by the amplitude determining parameters bⱼ and the phase determining parameters mⱼ of the pair minimizing the square error in the optimum solutions of all of the pairs. At a third stage and thereafter, operation similar to that in the second stage is successively carried out repeatedly to thereby successively calculate the optimum solutions of the amplitude determining parameters bⱼ and the phase determining parameters mⱼ.

Specifically, first, as the amplitude determining parameters, there is constituted a group of the amplitude determining parameters by 0.67, 1.33, 2.00 by dividing a range equal to or smaller than 2.0 by 3 and there are determined all of combinations of the amplitude determining parameters b₁, b₂, b₃, b₄ from numerical values thereof. Further, as the phase determining parameters, there are respectively determined a group of a plurality of different numerical values at intervals of 0.2×10⁻¹² by numerical ranges at vicinities of the first optimum solutions of the respective phase determining parameters m₁, m₂, m₃, m₄ (ranges equal to or larger than values produced by subtracting 0.4×10⁻¹² from the first optimum solutions and equal to or smaller than values produced by adding 0.4×10⁻¹² to the first optimum solutions) and there are determined all of different combinations of the phase determining parameters m₁, m₂, m₃, m₄ (all of sets of the phase determining parameters mⱼ) from numerical values of the group.

Next, there are determined all of combinations (all of pairs) of all of combinations of the determined amplitude determining parameters b₁, b₂, b₃, b₄ and all of different combinations of the phase determining parameters m₁, m₂, m₃, m₄, the combinations (pairs) are substituted for the amplitude determining parameters b₁, b₂, b₃, b₄ and the phase determining parameters m₁, m₂, m₃, m₄ in Equation (3) one by one, there is carried out nonlinear fitting to minimize square error between respective theoretical values and the target loss wavelength characteristic of the optical filter apparatus when the combinations are substituted for the amplitude determining parameters b₁, b₂, b₃, b₄ and the phase determining parameters m₁, m₂, m₃, m₄ in the theoretical equation one by one, there are calculated optimum solutions of the respective amplitude determining parameters b₁, b₂, b₃, b₄ and the phase determining parameters m₁, m₂, m₃, m₄ and second optimum solutions are constituted by the optimum values minimizing square error in the respective optimum solutions in all of the combinations.

Further, next, combinations of the amplitude determining parameters b₁, b₂, b₃, b₄ at a third stage are made values the same as those in the second stage. Further, as phase determining parameters, there is respectively determined a group of a plurality of different numerical values at intervals of 0.1×10⁻¹² by numerical ranges (in this case, ranges equal to or larger than values produced by subtracting 0.2×10⁻¹² from the second optimum solutions and equal to or smaller than values produced by adding 0.2×10⁻¹² to the second optimum values) at vicinities of the second optimum solutions of the respective phase determining parameters m₁, m₂, m₃, m₄. Further, by operation similar to the operation of calculating the second optimum solutions, there are calculated third optimum solutions of the respective amplitude determining parameters b₁, b₂, b₃, b₄ and the phase determining parameters m₁, m₂, m₃, m₄ (third optimum solutions of the amplitude determining parameters bⱼ and the phase determining parameters mⱼ) by carrying out nonlinear fitting.

Next, combinations of the amplitude determining parameters b₁, b₂, b₃, b₄ are made values the same as the optimum value at the second stage, further, as the phase determining parameters, there is respectively determined a group of a plurality of different numerical values at intervals of 0.05×10⁻¹² by numerical ranges (in this example, ranges equal to or larger than values produced by subtracting 0.1×10⁻¹² from the third optimum solutions and equal to or smaller than values produced by adding 0.1×10⁻¹² to the third optimum solutions) at vicinities of the third optimum solutions of the respective phase determining parameters m₁, m₂, m₃, m₄ and fourth optimum solutions of the respective amplitude determining parameters b₁, b₂, b₃, b₄ and the phase determining parameters m₁, m₂, m₃ m₄ are calculated by carrying out nonlinear fitting by operation similar to the above-described.

Next, combinations of the amplitude determining parameters b₁, b₂, b₃, b₄ are made values the same as the optimum value at the second stage, further, as the phase determining parameters, there is respectively determined a group of a plurality of different numerical values at intervals of 0.03×10⁻¹² by numerical ranges (in this example, ranges equal to or larger than values produced by subtracting 0.06×10⁻¹² from the fourth optimum solutions and equal to or smaller than values produced by adding 0.06×10⁻¹² to the fourth optimum solutions) at vicinities of the fourth optimum solutions of the respective phase determining parameters m₁, m₂, m₃, m₄ and fifth optimum solutions of the respective amplitude determining parameters b₁, b₂, b₃, b₄ and the phase determining parameters m₁, m₂, m₃, m₄ are calculated by carrying out nonlinear fitting by operation similar to the above-described.

Next, combinations of the amplitude determining parameters b₁, b₂, b₃, b₄ are made values the same as the optimum value at the second stage, further, as the phase determining parameters, there is respectively determined a group of a plurality of different numerical values at intervals of 0.02×10⁻¹² by numerical ranges (in this example, ranges equal to or larger than values produced by subtracting 0.04×10⁻¹² from the fifth optimum solutions and equal to or smaller than values produced by adding 0.04×10⁻¹² to the fifth optimum solutions) at vicinities of the fifth optimum solutions of the respective phase determining parameters, m₁, m₂, m₃, m₄ and sixth optimum solutions of the respective amplitude determining parameters b₁, b₂, b₃, b₄ and the phase determining parameters m₁, m₂, m₃, m₄ are calculated by carrying out nonlinear fitting by operation similar to the above-described.

Further, at an n-th stage (“n” is an integer equal to or larger than 7) thereafter, there are used values the same as the optimum solutions at the second stage for combinations of the amplitude determining parameters b₁, b₂, b₃, b₄. Further, when as the phase determining parameters, there are determined groups of numerical values in numerical ranges at vicinities of optimum solutions calculated at (n−1)-th stage of the respective phase determining parameters m₁, m₂, m₃, m₄, there are determined ranges equal to or larger than values produced by subtracting an interval used in calculating optimum solutions at the (n−1)-th stage and equal to or smaller than values produced by adding the interval to the optimum solutions and within the ranges, there is determined a group of different numerical values at an interval, which is, for example, a half of the interval used in calculating the optimum solutions at the (n−1)-th stage. Further, by operation similar to the above-described, there are successively calculated optimum solutions of the respective amplitude determining parameters b₁, b₂, b₃, b₄ and the phase determining parameters m₁, m₂, m₃, m₄ by carrying out nonlinear fitting.

Further, a set converging condition is constituted when an interval (converging condition) of groups of numerical values in calculating optimum solutions of the respective phase determining parameters m₁, m₂, m₃, m₄ becomes 0.0025×10⁻¹² and the above-described calculation is carried out until the set converging condition is reached (up to 9-th stage in this example).

The above-described is the first specific example of the method of calculating the optimum solutions of the amplitude determining parameters bⱼ and the phase determining parameters mⱼ.

Next, a description will be given of a second specific example of method of calculating optimum solutions of the amplitude determining parameters bⱼ and the phase determining parameters mⱼ.

According to the second specific example, first, for example, when initial values of the amplitude determining parameters bⱼ are determined, maximum values of absolute values of light transmission loss in the loss wavelength characteristic of all of the etalon filters 5 constituting the optical filter apparatus 6, are determined to be equal to or smaller than a maximum value of an absolute value of light transmission loss in the target loss wavelength characteristic of the optical filter apparatus 6.

Specifically, from a distribution of arranging the dots “a” of FIG. 1, it is known that the maximum value of the absolute value of the target loss wavelength characteristic is 3.93 (absolution value of −3.93 dB constituting a minimum value of the target loss wavelength characteristic) Therefrom, a maximum value of initial values of the respective amplitude determining parameters bⱼ is constituted by a value of 1.47 of the amplitude determining parameter at which an absolute value of an amplitude calculated by setting the term of sin as 1 in Equation (2) becomes 3.93 dB. Further, numerical values of a group of initial values of the amplitude determining parameter are determined by using a plurality of values equal to or smaller than 1.47 (for example, 3 through 5 values at equal intervals).

Further, as an example, the group of initial values of the phase determining parameters may be set by numbers within ranges including a predetermined set number of peaks as a result of subjecting the target loss wavelength characteristic of the optical filter apparatus to Fourier transformation. For example, FIG. 3 shows a result of replacing frequencies by the phase determining parameters with respect to the result of subjecting the target loss wavelength characteristic to Fourier transformation. In FIG. 3, the group of initial values of the phase determining parameters may be set in ranges (in ranges of the graph on the abscissa) including a predetermined plurality of peaks from ranges having large values of the peaks, for example, the group of initial values of the phase determining parameters is set by values equal to or smaller than 1.2×10⁻¹² including four of peaks from the maximum one.

Specifically, as the first stage, the group of initial values of the amplitude determining parameters is constituted by 0.29, 0.59, 0.88, 1,18, 1.47 produced by dividing 1.47 by 5 and all of combinations of the amplitude determining parameters b₁, b₂, b₃, b₄ are determined from the group of numerical values. The group of initial values of the phase determining parameters are determined to be numerical values different from each other from 0.1×10⁻¹² to 1.2×10⁻¹² at intervals of 0.1×10⁻¹² and all of different combinations of the phase determining parameters m₁, m₂, m₃, m₄ are determined from the group of numerical values. Further, similar to the above-described first specific example, there are calculated first optimum solutions of the respective amplitude determining parameters b₁, b₂, b₃, b₄ and the phase determining parameters m₁, m₂, m₃, m₄.

Next, as the second stage, a group of initial values of the amplitude determining parameters is constituted by 0.49, 0.98, 1.47 produced by dividing 1.47 by 3 and all of combinations of the amplitude determining parameters b₁, b₂, b₃, b₄ are determined from the group of numerical values. With regard to the phase determining parameters, there is respectively determined a group of a plurality of numerical values different from each other of values produced by subtracting 0.1×10⁻¹² from the respective first optimum solutions of m₁, m₂, m₃, m₄ and values produced by adding 0.1×10⁻¹² thereto at intervals of 0.04×10⁻¹² and all of different combinations of the phase determining parameters m₁, m₂, m³, m⁴ are determined from the numerical values of the group. Further, similar to the above-described, second optimum solutions of the respective amplitude determining parameters b₁, b₂, b₃, b₄ and the phase determining parameters m₁, m², m³, m₄ are calculated by using nonlinear fitting.

Further, at an n-th stage (“n” is an integer equal to or larger than 3) thereafter, combinations of the amplitude determining parameters b₁, b₂, b₃, b₄ are provided with values the same as those in the second stage. The phase determining parameters m₁, m₂, m₃, m₄ are set to numerical value ranges at vicinities of optimum solutions calculated at a (n−1)-th stage of the respective phase determining parameters m₁, m₂, m₃, m₄ and there are determined ranges equal to or larger than values produced by subtracting an interval used in calculating the optimum solutions at the (n−1)-th stage from the optimum solutions calculated at the (n−1)-th stage and equal to or smaller than values produced by adding the interval to the optimum solutions calculated at the (n−1)-th stage. Further, there is determined a group of different numerical values at an interval which is, for example, a half of the interval used in calculating the optimum solutions in the (n−1)-th stage within the ranges. Further, by operation similar to the above-described, there are calculated optimum values of the respective amplitude determining parameters b₁, b₂, b₃, b₄ and the phase determining parameters m₁, m₂, m₃, m₄ by carrying out nonlinear fitting.

Further, according to one embodiment thereof, as described above, when the frequency of incident light is designated by notation “f”, the phase factor of the loss wavelength characteristic of the etalon filter 5 is represented in the form of 2πfmⱼ. Therefrom, according to the second specific example, in calculating the optimum solutions of the respective phase determining parameters mⱼ by nonlinear fitting, when a numerical value interval of the group of numerical values substituted for the respective phase determining parameters mⱼ, is narrowed to substantially (1/f) as a set converging condition (specifically, a stage in which 1/f becomes 0.0050×10⁻¹² since in a wavelength range of 1530 nm through 1560 nm, 1/f is 0.0051×10⁻¹² through 0.0078×10⁻¹²), the calculation is finished.

The above-described is the second specific example of the method of calculating optimum solutions of the amplitude determining parameters bⱼ and the phase determining parameters mⱼ. When the method of the second specific example is applied, a number of times of extra calculation can further be reduced in comparison with that in the first specific example and efficiency of designing the optical filter apparatus can be achieved.

Further, as a result (final optimum solution) of calculating the respective amplitude determining parameters bⱼ and the phase determining parameters mⱼ by both of the first and the second specific examples, b₁=264.4715, m₁=0.0051×10⁻¹², b₂=0.4319, m₂=0.4524×10⁻¹², b₃=0.3915, m₃=0.6721×10⁻¹², b₄=0.1587, m₄=0.8607×10⁻¹².

Next, an explanation will be given of a third specific example of a method of calculating the amplitude determining parameters bⱼ and the phase determining parameters mⱼ.

Also in the third specific example, similar to the first or the second specific example, initial values of the amplitude determining parameters bⱼ and initial values of the phase determining parameters mⱼ are determined, thereafter, calculation is carried out successively substantially similar to the first or the second specific example and optimum solutions of the amplitude determining parameters bⱼ and the phase determining parameters mⱼ are calculated. However, according to the third specific example, in solutions of the phase determining parameters mⱼ and the amplitude determining parameters bⱼ calculated at respective stages by nonlinear fitting, only values within ranges predicted by the respective etalon filters 5 constituting the optical filter apparatus 6, are applied as optimum solutions.

Specifically, the amplitude determining parameter bⱼ and the phase determining parameter mⱼ of the etalon filter 5 are respectively determined by Equation (6) and Equation (7) when reflectance of the respective etalon filter 5 is designated by notation Rⱼ, incident angle (incident angle vertically incident on a filter face is set to 0) is designated by notations θⱼ, refractive index of a etalon filter is designated by notation nⱼ, a thickness of the etalon filter is designated by notation dⱼ and the velocity of light is designated by notation “c”. The amplitude determining parameter bⱼ is determined only by the reflectance Rⱼ and the phase determining parameter mⱼ is determined by the incident angle θⱼ, the refractive index nⱼ of the filter board and the thickness dⱼ, of the etalon filter.

bⱼ=4Rⱼ/{(1−Rⱼ)²} (6)

$${m}_{j} = \frac{2 {n}_{j} {d}_{j} \sqrt{I - \frac{{sin}^{2} {θ}_{j}}{{n}_{j}^{2}}}}{c} \qquad ( 7 )$$

Further, also in these equations, the suffix “j” is a value for identifying the respective etalon filter 5, for example, j=1 for the etalon filter 5 at the leftest side in FIG. 2, j=2 for the etalon filter 5 contiguous thereto, j=3 for the etalon filter contiguous thereto and j=4 for the etalon filter 5 at the rightest side.

According to the third specific example, when optimum solutions of the amplitude determining parameter bⱼ and the phase determining parameter mⱼ are calculated, a consideration is given to the reflectance Rⱼ, the incident angle θⱼ, the refractive index nⱼ and the thickness dⱼ. For example, since the thickness dⱼ of the etalon filter 5 which can be fabricated actually, is equal to or larger than 20 μm, in this example, optimum solutions of the amplitude determining parameter bⱼ and the phase determining parameter mⱼ are calculated by a method of adopting a constitution in which the solution of the phase determining parameter mⱼ by nonlinear fitting, is equal to or larger than 0.1926×10⁻¹².

When the respective amplitude determining parameter bⱼ and the phase determining parameter mⱼ are calculated by the third specific example, b₁=0.4431, m₁=0.1952×10⁻¹², b₂=0.3514, m₂=0.4986×10⁻¹², b₃=0.3833, m₃=0.6874×10⁻¹², b₄=0.1457, m₄=0.8760×10⁻¹².

When the method of the third specific example is applied, there can be designed a precise optical filter apparatus in correspondence with a condition of actually fabricating the etalon filters 5.

Further, even in the case of carrying out design by any of the above-described specific examples, when 0 is put to the phase determining parameter mⱼ, a direct current component is produced and there is needed one extra etalon filter for producing a bias amount. Hence, the calculation is simplified by determining the group of numerical values of the phase determining parameters mⱼ such that the phase determining parameters do not include 0, further, the cost in design can be reduced. In consideration thereof, according to the embodiment, the above-described respective calculation is carried out by determining the group of numerical values of the phase determining parameters mⱼ such that the phase determining parameters do not include 0.

Further, in one embodiment thereof, by using the amplitude determining parameters bⱼ and the phase determining parameters mⱼ calculated by the third specific example, Equation (6) and Equation (7), the reflectance Rⱼ and the incident angle θⱼ of the etalon filter 5, the refractive index nⱼ of the etalon filter and the thickness dⱼ of the etalon filter are respectively determined and the respective filter 5 is designed.

Further, in designing the etalon filter 5, in order to selected from the wavelength range (1530 nm through 1560 nm) of the target loss wavelength characteristic, there are provided values indicated by a characteristic line “b” of FIG. 1, which can be confirmed to substantially coincide with the dots “a” of the target loss wavelength characteristic shown in FIG. 1.

Further, FIG. 3 shows the phase determining parameters of the respective etalon filters 5 in the optical filter according to an embodiment thereof by arrow marks. As is apparent from FIG. 3, according to the method of conventional example of determining phases from a frequency band having peaks at frequency components by Fourier transformation, the respective etalon filters 5 having the phase determining parameters as in the embodiment cannot be designed. Therefore, it is confirmed that according to the conventional method, the optical filter apparatus having the characteristic substantially coinciding with the target loss wavelength characteristic as in the embodiment cannot be constituted.

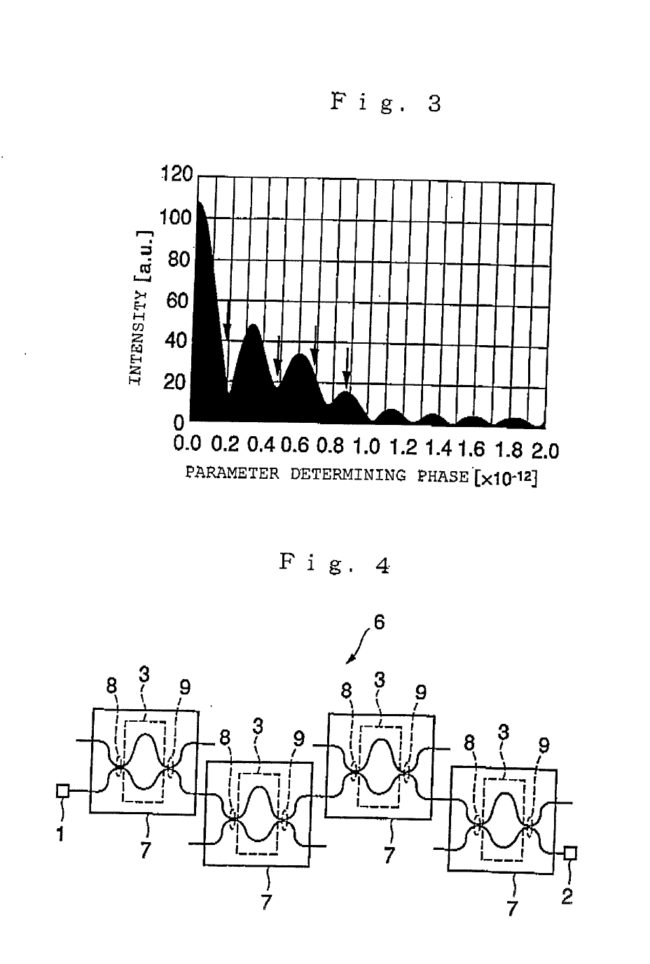

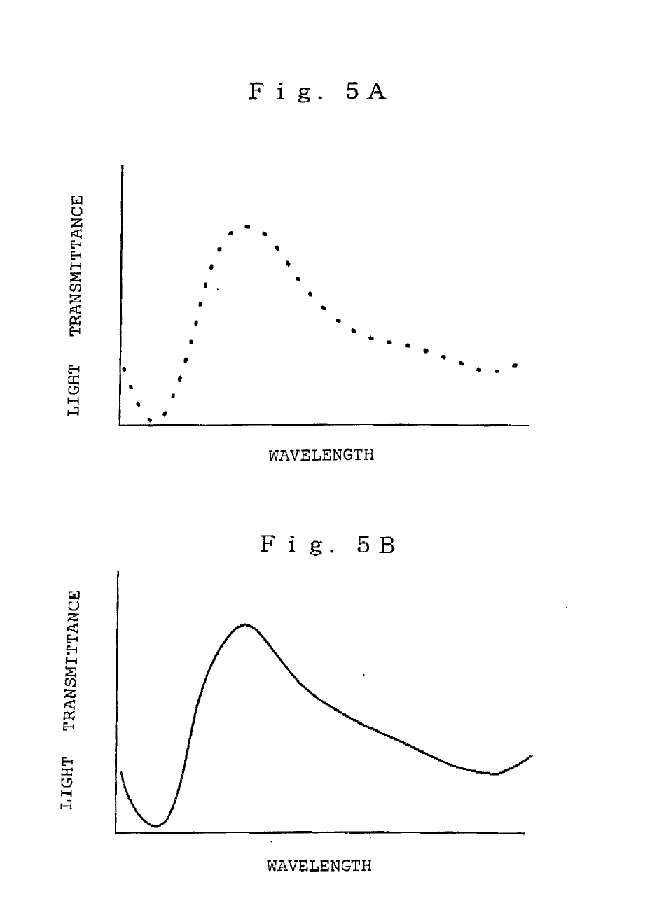

Next, an explanation will be given of a second embodiment of an optical filter apparatus according to the invention. As shown by FIG. 4, the second embodiment is provided with 4 parts of Mach-Zender interference type optical elements 7. A difference of the second embodiment from the first embodiment resides in that optical parts constituting the optical filter apparatus 6 are constituted by the Mach-Zender interference restrain polarization dependency, the incident angle is set to 0, as the refractive index of the etalon filter, refractive index of 1.445 of silica is used and the thickness of the respective etalon filter 5 is determined.

As a result, according to the example, R₁=9.144%, R₂=7.515%, R₃=8.094%, R₄=3.400%, d₁=20.27 μm, d₂=51.77 μm, d₃=71.38 μm, d₄=90.95 μm.

Further, by combining the designed etalon filters 5, there is designed and fabricated the optical filter apparatus having the target loss wavelength characteristic.

According to an embodiment, since the optical filter apparatus is designed by the above-described design method and fabricated, by carrying out nonlinear fitting very efficiently, there can efficiently be designed and fabricated the optical filter apparatus having the loss wavelength characteristic most proximate to the target loss wavelength characteristic. Therefore, there can be constituted the excellent optical filter apparatus capable of substantially completely compensating for the gain wavelength dependency in the previously set wavelength range including the wavelength used by the optical amplifying apparatus.

When the light transmission loss of the optical filter apparatus 6 according to the embodiment is actually measured at a plurality of wavelengths λ₁ (“i” is an integer incremented by 1 successively from 1 through N as in 1, 2, 3, . . . ) arbitrarily type optical elements 7. A method of designing the optical filter apparatus according to the second embodiment is substantially similar to the method of designing the optical filter apparatus according to the first embodiment. Further, in FIG. 4, numeral 1 designates a light input portion and numeral 2 designates a light output portion.

As is well known, the Mach-Zender interference type optical element 7 is provided with a function substantially similar to that of the etalon filter 5. A loss wavelength characteristic thereof is represented by Equation (8) by designating the frequency by notation “f” and using respective parameters similar to those of the first embodiment. Further, the loss wavelength characteristic is represented by Equation (9) when represented by dB unit.

T=1−bⱼ×{sin²(π·f·mⱼ)} (8)

T=10×log₁₀{1−bⱼ·sin²(π·f·mⱼ)} (9)

Further, the suffix “j” is a value for identifying the Mach-Zender interference type optical element 7, for example, j=1 for the Mach-Zender interference type optical element 7 at the leftest side, j=2 for the Mach-Zender interference type optical element 7 contiguous thereto, j=3 for the Mach-Zender interference type optical element 7 contiguous thereto and j=4 for the Mach-Zender interference type optical element 7 at the rightest side in FIG. 4.

In the second embodiment, the loss wavelength characteristic of the optical filter apparatus having four of the Mach-Zender interference type optical elements 7, is approximated by Equation (10).

$$T = 10 \times {log}_{10} \{ 1 - {b}_{1} \cdot {sin}^{2} ( π \cdot f \cdot {m}_{1} ) \} + 10 \times {log}_{10} \{ 1 - {b}_{2} \cdot {sin}^{2} ( π \cdot f \cdot {m}_{2} ) \} + 10 \times {log}_{10} \{ 1 - {b}_{3} \cdot {sin}^{2} ( π \cdot f \cdot {m}_{3} ) \} + 10 \times {log}_{10} \{ 1 - {b}_{4} \cdot {sin}^{2} ( π \cdot f \cdot {m}_{4} ) \} \qquad ( 10 )$$

As is well known, the Mach-Zender interference type optical element is formed by combining two of light waveguides and making lengths thereof by lengths different from each other. As shown by FIG. 4, the respective Mach-Zender interference type optical element 7 is provided with an optical path length differentiating portion 3 between two directional couplers 8 and 9. When in the respective Mach-Zender interference type optical element 7 constituting the second embodiment, coupling rates of the two directional couplers 8 and 9 are made equal to each other, a value thereof is designated by notation αⱼ, an optical path length difference is designated by notation ΔLⱼ and refractive index of an optical path is designated by notation nⱼ, the amplitude determining parameter bⱼ of the respective Mach-Zender 7 interference type optical element can be represented by Equation (11) and the phase determining parameter mⱼ can be represented by Equation (12).

bⱼ=4αⱼ(1−αⱼ) (11)

mⱼ=(2nⱼ·ΔLⱼ)/c (12)

According to the second embodiment, by using Equations (10) through (12) and applying a method of designing an optical filter similar to that of the specific example 3 in the first embodiment, an optical filter apparatus having a target loss wavelength characteristic similar to that of the first embodiment is designed and fabricated by combining the four Mach-Zender interference type optical elements 7.

The second embodiment is designed also by a method of designing an optical filter apparatus similar to that in the first embodiment and therefore, there can be achieved an effect similar to that of the first embodiment.

Further, the invention is not limited to the above-described respective embodiments but can adopt various modes of embodiments. For example, according to the above-described first embodiment, the optical filter apparatus 6 is designed and fabricated by combining four etalon filters 5 and according to the above-described second embodiment, the optical filter apparatus 6 is designed and fabricated by combining four of the Mach-Zender interference type optical elements 7. However, kinds and numbers of optical parts constituting the optical filter apparatus 6 are not particularly limited but are set optionally. The optical filter apparatus according to the invention is designed and fabricated in various modes by combining N (N is an integer equal to or larger than 2) of optical parts each having a periodic loss wavelength characteristic with respect to wavelength.

Further, although in the above-described first embodiment, the incident angle of four etalon filters 5 is set to 0, the incident angle of the etalon filter 5 is not necessarily limited to 0, for example, as in an etalon filter 5a indicated by broken lines of FIG. 2, the etalon filter 5 may be arranged obliquely to thereby constitute the incident angle by an angle other than 0. There also is the case in which by adjusting the incident angle of the etalon filter 5 in this way, the loss wavelength characteristic of the optical filter apparatus 6 can further be proximate to the target loss wavelength characteristic.

Further, although according to the above-described respective embodiments, the groups of numerical values substituted for the amplitude determining parameters and the phase determining parameters, are constituted by the groups of pluralities of numerical values at equal intervals, the interval between numerical values constituting the groups of numerical values substituted for the amplitude determining parameters and the phase determining parameters, is not particularly limited but set pertinently. There also is a case in which the respective parameters are calculated precisely when the intervals are nonuniform.

As has been explained above, according to the method of designing the optical filter apparatus of the embodiment of the invention, in determining the phase determining parameters for determining the phases of the loss wavelength characteristics of the plurality of respective optical parts constituting the optical filter apparatus and the amplitude determining parameters for determining amplitudes of the loss wavelength characteristics of the respective optical parts, precise values of the respective parameters can be calculated very efficiently without repeating operation of calculating the optimum solutions by variously changing the initial values of the respective parameters substituted for the theoretical equation of the loss wavelength characteristic of the optical filter apparatus including the respective parameters. Therefore, by carrying out nonlinear fitting very efficiently, the optical filter apparatus having the loss wavelength characteristic very proximate to the target loss wavelength characteristic can be designed by the plurality of optical parts.

What is claimed is:

1. A method of designing an optical filter apparatus for designing the optical filter apparatus by combining N (N is an integer equal to or larger than 2) having periodic loss wavelength characteristics with respect to a wavelength, said method comprising the steps of;
approximating a loss wavelength characteristic of the optical filter apparatus by a theoretical equation having phase determining parameters mⱼ (j is an integer incremented by 1 successively from 1 through N as in 1, 2, 3, . . . N) for determining phases of the loss wavelength characteristics of N of the respective optical parts and amplitude determining parameters bⱼ for determining amplitudes of the loss wavelength characteristics of the respective optical parts;
determining a predetermined group of a plurality of different numerical values as a first stage;
determining all of sets of the phase determining parameters mⱼ comprising N of numerical values different from each other having different combinations of the numerical values from the numerical values of the group of initial values of the phase determining parameters;
calculating solutions minimizing a square error between respective theoretical values and a target loss wavelength characteristic of the optical filter apparatus when the numerical values of the phase determining parameters of the respective optical parts of the respective phase determining parameters mⱼ of the respective sets, are substituted for the phase determining parameters mⱼ in the theoretical equation providing the initial values of the amplitude determining parameters bⱼ, as first optimum solutions of the phase determining parameters mⱼ by nonlinear fitting;
thereafter determining respective groups of numerical values in ranges proximate to respective numerical values constituting the first optimum solutions of the phase determining parameters mⱼ and determining the phase determining parameters on mⱼ of all of sets having different combinations of numerical values by selecting numerical values one by one from the groups of the respective numerical values as a second stage;
calculating solutions minimizing the square error between the respective theoretical values and the target loss wavelength characteristic of the optical filter apparatus when the numerical values of the phase determining parameters of the respective optical parts are substituted for the phase determining parameters mⱼ in the theoretical equation at the respective phase determining parameters mⱼ of the respective sets as second optimum solutions of the phase determining parameters mⱼ by the nonlinear fitting,
successively calculating the optimum solutions of the phase determining parameters mⱼ by repeatedly carrying out an operation similar to an operation at the second stage at a third stage and thereafter;
determining the phase determining parameters mⱼ calculated when a predetermined condition of converging in accordance with calculating the optimum solutions reaches a set converging condition as final optimum solutions and designing N of the respective optical parts by using the phase determining parameters mⱼ of the final optimum solutions; and
constituting the optical filter apparatus having the target loss wavelength characteristic by combining N of the designed optical parts.

2. The method of designing an optical filter apparatus according to claim 1, further comprising the steps of:
determining a predetermined group of a plurality of different numerical values as a group of initial values of amplitude determining parameters bⱼ as the first stage;
determining all of sets of the amplitude determining parameters bⱼ comprising N of numerical values having different combinations of numerical values from the numerical values of the group of the initial values of the amplitude determining parameters;
making all of pairs combined with all of the sets of the amplitude determining parameters bⱼ and all of the sets of the phase determining parameters mⱼ set by set;
calculating solutions minimizing a square error between respective theoretical values and the target loss wavelength characteristic of the optical filter apparatus when the numerical values of the amplitude determining parameters bⱼ and the phase determining parameters mⱼ are substituted for the amplitude determining parameters bⱼ and the phase determining parameters mⱼ in the theoretical equation pair by pair from all of the pairs as first optimum solutions of the amplitude determining parameters bⱼ and the phase determining parameters mⱼ by the nonlinear fitting;
calculating optimum solutions up to a set stage by repeating a similar operation in an operation of calculating the optimum solutions of the amplitude determining parameters bⱼ at the second stage and thereafter, calculating the optimum solutions at the set stage and thereafter by using the numerical values of the optimum solutions calculated at the set stage in the set stage and thereafter or successively repeating a method of calculating the optimum solutions until the set stage and calculating final optimum solutions of the phase determining parameters mⱼ and the amplitude determining parameters bⱼ; and
designing N of the respective optical parts by using the phase determining parameters mⱼ and the amplitude determining parameters bⱼ of the final optimum solutions.

3. The method of designing an optical filter apparatus according to claim 1:
wherein the optical filter apparatus is designed by determining initial values of respective amplitude determining parameters bⱼ such that maximum values of absolute values of light transmission loss in the loss wavelength characteristics of combinations of all of the optical parts constituting the optical filter apparatus, become equal to or smaller than a maximum value of an absolute value of the light transmission loss in the target loss wavelength characteristic of the optical filter apparatus.

4. The method of designing an optical filter apparatus according to claim 1:
wherein the group of the initial values of the phase determining parameters is set by using numerical values in a range of numerical values on an abscissa from a side of a maximum peak to a predetermined set number of peaks in a graph of a waveform curve provided by subjecting the target loss wavelength characteristic of the optical filter apparatus to Fourier transformation.

5. The method of designing an optical filter apparatus according to claim 1:
wherein the optical filter apparatus is designed by combining the optical parts in each of which a phase factor of the loss wavelength characteristic of the optical part is represented by a form of 2πfmⱼ when a frequency of incident light is designated by a notation f; and
wherein the optical filter apparatus is designed by constituting a set converging condition when a numerical interval of the group of numerical values substituted for the respective phase determining parameters mⱼ when the optimum solutions of the respective phase determining parameters mⱼ are calculated by the nonlinear fitting, is narrowed to substantially (1/f).

6. The method of designing an optical filter apparatus according to claim 2:
wherein only values in ranges predicted from the respective optical parts constituting the optical filter apparatus in the solutions of the phase determining parameters mⱼ and the amplitude determining parameters bⱼ calculated at the respective stages, are applied as the optimum solutions.

7. The method of designing an optical filter apparatus according to claim 1:
wherein a set converging condition is given by a value of a numerical value interval when the group of numerical values for selecting the numerical values of the phase determining parameters mⱼ, is given by a numerical value series at equal intervals;
wherein the numerical interval of the numerical value series of the group of numerical values for selecting the phase determining parameters, is reduced in accordance with progressing the stages of calculating the optimum solutions; and
wherein the solutions of the phase determining parameters mⱼ calculated when the numerical value interval of the numerical value series given to the group of numerical values for selecting the phase determining parameters reaches the interval of the set converging condition in accordance with progressing the stages of calculating the optimum solutions, are determined as final optimum solutions.

8. The method of designing an optical filter apparatus according to claim 1:
wherein the group of numerical values for selecting the phase determining parameters are set such that the group of numerical values does not include a numerical value of 0.

9. The method of designing an optical filter apparatus according to claim 1:
wherein the optical parts are etalon filters.

10. The method of designing an optical filter apparatus according to claim 1:
wherein the optical parts are Mach-Zender interference type optical elements.

11. An optical filter apparatus designed and fabricated by using the method of designing an optical filter apparatus according to claim 1.
